(19) United States
(12) Patent Application Publication
(10) Pub. No.: US 2025/0069610 A1
(43) Pub. Date: Feb. 27, 2025

(54) AUDIO PROCESSING METHOD, ELECTRONIC APPARATUS AND STORAGE MEDIUM

(71) Applicant: Beijing Zitiao Network Technology Co., Ltd., Beijing (CN)

(72) Inventors: Yao LIU, Beijing (CN); Yixiu HUANG, Beijing (CN); Liyang HAN, Beijing (CN); Lin BAO, Beijing (CN); Weisi WANG, Beijing (CN)

(21) Appl. No.: 18/725,578

(22) PCT Filed: Dec. 20, 2022
(86) PCT No.: PCT/CN2022/140468

§ 371 Date: Jun. 28, 2024

(30) Foreign Application Priority Data
Dec. 30, 2021 (CN) 202111654061.6

(51) Int. Cl. G10L 19/022

(52) U.S. Cl. CPC G10L 19/022

(57) ABSTRACT

Embodiments of the present disclosure provide an audio processing method, electronic apparatus and computer-readable storage medium. The method includes: determining a decoding start frame identification and a decoding end frame identification in a preset frame sequence, in which the preset frame sequence includes frame information of audio frames in at least one audio resource, the frame information includes a frame identification, the frame identification includes an audio resource identification and a frame index; acquiring segment data to be decoded in an audio resource associated with a corresponding audio resource identification according to the decoding start frame identification and the decoding end frame identification; and decoding the segment data to be decoded to obtain corresponding target decoded data.

This application claims the priority of Chinese Patent Application No. 202111654061.6 filed on Dec. 30, 2021, the disclosure of which is incorporated by reference herein in its entirety as part of the present application.

### TECHNICAL FIELD

Embodiments of the present disclosure relate to the field of audio processing technology, for example, to an audio processing method, a device, an apparatus, and a storage medium.

### BACKGROUND

With the development of audio technology, there are more and more application scenarios involving playback or editing of audio. In these application scenarios, there are many sources of audio files that need to be processed, but decoding of audio files is usually required during the processing.

At present, when audio files are large or have a long duration, the decoding process is complex and time-consuming, which affects audio processing performance. Taking the application scenario involving web front-end as an example, when processing audio files, the web front-end usually performs full decoding of the audio files. When the audio files are large or have a long duration, it is easy to occupy a large amount of memory during the decoding process, leading to browser crashes, and operating a large amount of memory can seriously affect machine performance, at the same time, the full decoding process is time-consuming, making it difficult to ensure the timeliness of audio processing.

### SUMMARY

Embodiments of the present disclosure relate to an audio processing method, a device, an apparatus, and a storage medium, which can improve the audio processing methods in the related art.

In the first aspect, the embodiments of the present disclosure provide an audio processing method, which includes:
determining a decoding start frame identification and a decoding end frame identification in a preset frame sequence, in which the preset frame sequence comprises frame information of a plurality of audio frames in at least one audio resource, the frame information includes a frame identification, the frame identification includes an audio resource identification and a frame index, the audio resource identification is used to represent an identity of an audio resource to which a corresponding audio frame belongs, the frame index is used to represent an order of a corresponding audio frame in all audio frames of the audio resource to which the corresponding audio frame belongs;
acquiring segment data to be decoded in an audio resource associated with a corresponding audio resource identification according to the decoding start frame identification and the decoding end frame identification; and
decoding the segment data to be decoded to obtain corresponding target decoded data.

In the second aspect, the embodiments of the present disclosure provide an audio processing device, which includes:
a frame identification determination module, configured to determine a decoding start frame identification and a decoding end frame identification in a preset frame sequence, in which the preset frame sequence includes frame information of a plurality of audio frames in at least one audio resource, the frame information includes a frame identification, the frame identification includes an audio resource identification and a frame index, the audio resource identification is used to represent an identity of an audio resource to which a corresponding audio frame belongs, the frame index is used to represent an order of a corresponding audio frame in all audio frames of an audio resource to which the corresponding audio frame belongs;
a decoded data acquisition module, configured to acquire segment data to be decoded in an audio resource associated with a corresponding audio resource identification according to the decoding start frame identification and the decoding end frame identification; and
a decoding module, configured to decode the segment data to be decoded to obtain corresponding target decoded data.

In the third aspect, the embodiments of the present disclosure provide an electronic apparatus, which includes a memory, a processor, and a computer program stored on the memory and capable of running on the processor, in which the processor implements the method provided by the embodiments of the present disclosure when executing the computer program.

In the fourth aspect, the embodiments of the present disclosure provide a computer-readable storage medium, on which a computer program is stored, the computer program implements the method provided by the embodiments of the present disclosure when executed by a processor.

### BRIEF DESCRIPTION OF DRAWINGS

FIG. 1 is a flowchart of an audio processing method provided by the embodiments of the present disclosure;

FIG. 2 is an architectural diagram of an audio processing method provided by the embodiments of the present disclosure;

FIG. 3 is a flowchart of another audio processing method provided by the embodiments of the present disclosure;

FIG. 4 is a schematic diagram of an audio playback control process provided by the embodiments of the present disclosure;

FIG. 5 is a structural diagram of an audio processing device provided by the embodiments of the present disclosure; and

FIG. 6 is a structural diagram of an electronic apparatus provided by the embodiments of the present disclosure.

### DETAILED DESCRIPTION

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of the messages or information exchanged between multiple devices in the embodiments of the present disclosure are for illustrative purposes only and are not intended to limit the scope of these messages or information.

In the following embodiments, example features and implementations are provided simultaneously in each embodiment, and the various features recorded in the embodiments can be combined to form multiple example solutions. Each numbered embodiment should not be considered as only one technical solution.

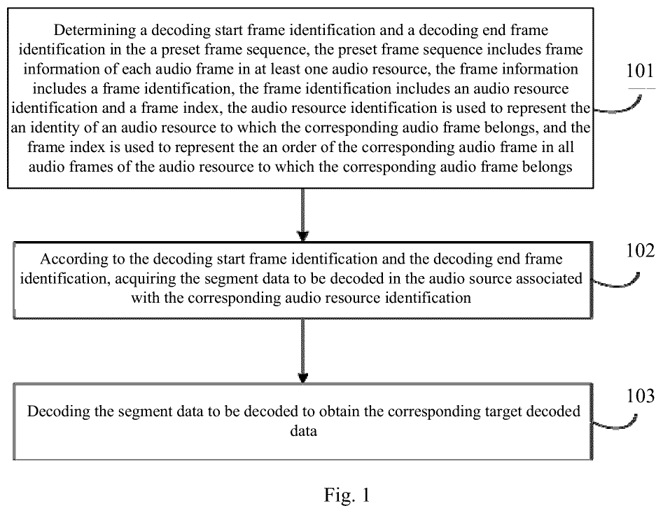

FIG. 1 is a flowchart of an audio processing method provided by the embodiments of the present disclosure, the method can be executed by an audio processing device and is applicable to application scenarios for decoding audio. The device can be implemented by software and/or hardware and can generally be integrated into an electronic apparatus. The electronic apparatus may be a mobile device such as a mobile phone, a smartwatch, a tablet, a personal digital assistant, and the like; and may also be other devices such as a desktop computer. As shown in FIG. 1, the method includes steps 101-103.

Step 101: determining a decoding start frame identification and a decoding end frame identification in a preset frame sequence, the preset frame sequence includes frame information of a plurality of audio frames in at least one audio resource, the frame information includes a frame identification, the frame identification includes an audio resource identification and a frame index, the audio resource identification is used to represent an identity of an audio resource to which the corresponding audio frame belongs, and the frame index is used to represent an order of the corresponding audio frame in all audio frames of the audio resource to which the corresponding audio frame belongs.

In the embodiments of the present disclosure, the audio resource can be understood as the original audio file, and the specific source is not limited. The audio resource may be the audio file stored locally on electronic apparatus, may be the audio file stored on servers (such as the cloud), or may also be the audio file from other sources. The audio resource stored on the server can be audio file uploaded by users to the server, or the audio file converted (for example, format conversion) from the audio file uploaded by users. The audio resource is associated with an audio resource identification, which is used to represent the identity of the audio resource and can be referred to as a resource identification (ID).

Generally, an audio file is composed of a series of encoded audio frames, the audio frames can be understood as the smallest unit that can independently decode the audio segment. The frame structures of audio frames in different formats of audio files may be different. Based on acoustic principles, the duration of each frame generally ranges from 20 ms (milliseconds) to 50 ms. The audio frame can maintain information related to them, such as the resource ID associated with the audio frame (i.e., the audio resource identification associated with the audio resource to which the audio frame belongs), the order of the audio frame in all audio frames of the audio resource to which the audio frame belongs, the position of the audio frame in the audio resource to which the audio frame belongs, the data size of the audio frame, and the meta information of the audio resource to which the audio frame belongs.

In the embodiments of the present disclosure, before this step, frame division processing can be performed on the audio resource to obtain the frame information of the plurality of audio frames in the audio resource, and the preset frame sequence can be constructed according to the frame information. Frame division processing can be understood as determining respectively the corresponding frame information of each audio frame in the audio resource. Exemplarily, the required information can be acquired in advance from the information maintained by the plurality of audio frames in one or more audio resources, and the corresponding frame information of the plurality of audio frames can be obtained through direct extraction and/or secondary calculation. The frame information may include the frame identification, and may also include other information, which is not limited specifically. The frame index refers to the order of the corresponding audio frame in all audio frames of the audio resource to which the corresponding audio frame belongs. For example, the frame index of the first audio frame in the audio resource can be recorded as 0, the frame index of the second audio frame can be recorded as 1, and so on. After obtaining the frame information of the plurality of audio frames, the frame information can be arranged in a preset order to obtain the preset frame sequence, that is, the objects in the preset frame sequence are sorted by frame information as the unit. The preset order can be set according to actual requirements without any specific limitations, and can also be dynamically adjusted according to actual requirements during the application process. For example, the preset order can be sorted according to the audio resource identification, i.e., the frame information associated with the same audio resource identification is arranged together. For frame information associated with the same audio resource identification, it can be sorted in order by frame index, i.e., the order of frame information is consistent with the original order of the plurality of audio frames in the audio resource to which the audio frame belongs, or the order may be sorted according to other orders. For example, there may be other frame information spaced between frame information of adjacent frame indexes, for example, there may be frame information with frame index 3 between frame information with frame index 1 and frame information with frame index 2. For example, the preset order may be to alternately sort the frame information corresponding to different audio resources, for example, there may be frame information with resource ID 2 between two frame information with resource ID 1.

In the embodiments of the present disclosure, the decoding start frame identification can be understood as the frame identification in the frame information corresponding to the first audio frame to be decoded at this time, and the decoding end frame identification can be understood as the frame identification in the frame information corresponding to the last audio frame to be decoded at this time. Exemplarily, when a preset decoding event being triggered is detected, the decoding start frame identification and the decoding end frame identification are determined in the preset frame sequence. The triggering condition for the preset decoding event is not limited and can be set according to actual decoding requirements. Decoding requirements may include playback requirements, decoding data buffering requirements, audio to text conversion requirements, and audio waveform drawing requirements, etc. The decoding requirements can be automatically determined according to the current usage scenario or according to user input operations. The preset decoding event can indicate the demand parameters for the current decoding requirements, the demand parameters may include, for example, the decoding start frame identification, the decoding end frame identification, or the target decoding duration, etc. For example, the decoding start frame identification and the decoding end frame identification in the preset frame sequence is determined according to the demand parameters. For example, when the demand parameters include the decoding start frame identification and the decoding end frame identification, the decoding start frame identification and the decoding end frame identification can be directly found in the preset frame sequence according to the decoding start frame identification and the decoding end frame identification. For example, when the demand parameters include the decoding start frame identification and the target decoding duration, the decoding start frame identification can be first found in the preset frame sequence according to the decoding start frame identification. Starting from the audio frame corresponding to the decoding start frame identification, the duration of the audio frame corresponding to the subsequent frame information in the preset frame sequence can be sequentially accumulated until the target decoding duration is reached. The decoding end frame identification can be determined according to the frame identification in the frame information at this time.

Step 102: According to the decoding start frame identification and the decoding end frame identification, acquiring segment data to be decoded in the audio source associated with the corresponding audio resource identification.

Exemplarily, the corresponding audio resource identification can be understood as the audio resource identification contained in the decoding start frame identification and/or the decoding end frame identification.

Exemplarily, assuming that the frame information to which the decoding start frame identification belongs can be recorded as the start frame information, and the frame information to which the decoding end frame identification belongs can be recorded as the end frame information. If the start frame information, the end frame information, and the frame information (which can be recorded as the intermediate frame information) between the start frame information and end frame information in the preset frame sequence all correspond to the same audio resource identification, it means that the audio frames to be decoded come from the same audio resource. The audio frames in corresponding order in the audio resource can be acquired according to the frame indexes respectively contained in the decoding start frame identification, the decoding end frame identification, and the frame identification (which can be recorded as the intermediate frame identification) contained in the intermediate frame information, and the segment data to be decoded can be obtained.

Exemplarily, if there are at least two different audio resource identifications in the audio resource identifications corresponding to the start frame information, the end frame information, and the intermediate frame information, it means that the audio frames to be decoded come from at least two audio resources. The audio frames in corresponding order can be acquired respectively from the audio resources associated with the corresponding audio resource identifications according to the frame indexes contained in the decoding start frame identification, the decoding end frame identification, and the intermediate frame identification, and the segment data to be decoded can be obtained.

Step 103: decoding the segment data to be decoded to obtain the corresponding target decoded data.

Exemplarily, after acquiring the segment data to be decoded, the preset decoding algorithm can be used or the preset decoding interface can be called to decode the segment data to be decoded, and the target decoded data required for this decoding can be determined according to the decoded result.

In the audio processing method provided by the embodiments of the present disclosure, the decoding start frame identification and the decoding end frame identification are determined in the preset frame sequence. The preset frame sequence includes frame information of the plurality of audio frames in at least one audio resource. The frame information includes the frame identification, the frame identification includes the audio resource identification and the frame index. The audio resource identification is used to represent the identity of the audio resource to which the corresponding audio frame belongs, and the frame index is used to represent the order of the corresponding audio frame in all audio frames of the audio resource to which the corresponding audio frame belongs. According to the decoding start frame identification and the decoding end frame identification, the segment data to be decoded in the audio resource associated with the corresponding audio resource identification is acquired, and the segment data to be decoded is decoded, and the corresponding target decoded data is obtained. By adopting the above technical scheme, the frame information of the plurality of audio frames in the audio resource is stored in sequence form in advance. When decoding is needed, the range of data to be decoded is accurately located according to the decoding start frame identification and the decoding end frame identification, and the segment data is acquired from the corresponding audio resource and decoded without the need for full decoding of audio files, thereby achieving on-demand decoding, making decoding more flexible and improving audio processing efficiency.

In some embodiments, determining the decoding start frame identification and the decoding end frame identification in the preset frame sequence includes: determining the target decoding duration and the decoding start frame identification; starting traversing in the preset frame sequence with the frame information corresponding to the decoding start frame identification as the start point, and determining the decoding end frame identification according to the corresponding frame information when the preset traversal termination condition is satisfied; the preset traversal termination condition includes the case: the cumulative duration of the audio frames corresponding to the traversed frame information reaches the target decoding duration. It accumulates the duration of the audio frames corresponding to the traversed frame information in a frame-by-frame traversal manner, and when the target decoding duration is reached, the traversal ends. The decoding of the audio frame data with the specified start position and the specified duration can be achieved according to the decoding start frame identification and the target decoding duration. The duration of each audio frame is generally related to the sampling rate of the audio resource to which it belongs. The corresponding sampling rate can be acquired according to the audio resource identification in the traversed current frame information, and then the duration of the audio frame corresponding to the current frame information can be determined.

Exemplarily, assuming that the cumulative duration obtained after accumulating the duration of the audio frames corresponding to the current frame information is greater than or equal to the target decoding duration, the frame identification in the current frame information can be determined as the decoding end frame identification.

In some embodiments, the preset traversal termination condition further includes at least one of the following items: the audio resource identification in the current frame information is inconsistent with the audio resource identification in the previous frame information; the frame index in the current frame information is not continuous with the frame index in the previous frame information; the frame index in the current frame information is the last one in the audio resource to which it belongs. When the preset traversal termination condition is satisfied, determining the decoding end frame identification according to the corresponding frame information includes: when any one item of the preset traversal termination condition is satisfied, determining the decoding end frame identification according to the corresponding frame information. By enriching the items in the preset traversal termination condition, the segment data to be decoded can come from the same audio resource, and the audio frames in the segment data to be decoded can be continuous. When any item is satisfied, the traversal is terminated, ensuring that each time the segment data to be decoded is acquired from the same audio resource, reducing the difficulty of acquiring the segment data to be decoded and improving the data acquisition efficiency.

Exemplarily, assuming that the audio resource identification in the current frame information is inconsistent with the audio resource identification in the previous frame information, the frame identification in the previous frame information can be determined as the decoding end frame identification; assuming that the frame index in the current frame information is not continuous with the frame index in the previous frame information, the frame identification in the previous frame information can be determined as the decoding end frame identification; assuming that the frame index in the current frame information is the last one in the audio resource to which it belongs, the frame identification in the current frame information can be determined as the decoding end frame identification.

In some embodiments, the frame information further includes a frame offset amount and a frame data amount; acquiring the segment data to be decoded in the audio resource associated with the corresponding audio resource identification according to the decoding start frame identification and the decoding end frame identification includes: determining the audio resource associated with the audio resource identification corresponding to the decoding start frame identification as the target audio resource; determining the data start position according to the first frame offset amount corresponding to the decoding start frame identification, determining the data end position according to the second frame offset amount corresponding to the decoding end frame identification and the frame data amount, and determining the target data range according to the data start position and the data end position; acquiring audio data within the target data range from the target audio resource, and obtaining the segment data to be decoded. In this way, the segment data to be decoded can be acquired more quickly and accurately.

Exemplarily, the frame offset amount can be understood as the start position of an audio frame in the audio resource to which it belongs, and the unit may be byte. The frame data amount can be understood as the size of the audio frame in the audio resource to which it belongs, the unit is usually the same as the unit of the frame offset amount, which can be the byte. The frame offset amount corresponding to the frame identification can be understood as the frame offset amount contained in the frame information where the frame identification is located, that is, the corresponding frame identification and frame offset amount are in the same frame information, and the same is true for the frame data amount. When the preset traversal termination condition includes all four items of the above, it can be ensured that the decoding start frame identification and the decoding end frame identification correspond to the same audio resource. The corresponding audio resource identification can be determined according to either of the decoding start frame identification and the decoding end frame identification, and the associated audio resource can be determined as the target audio resource. The start position of the data to be acquired in the target audio resource can be determined according to the first frame offset amount, and the end position of the data to be acquired in the target audio resource can be determined according to the second frame offset amount and the frame data amount (for example, the end position can be represented as the second frame offset amount+the frame data amount−1), thereby obtaining the target data range. According to this target data range, the corresponding audio data can be extracted from the target audio resource.

In some embodiments, starting traversing in the preset frame sequence with the frame information corresponding to the decoding start frame identification as the start point includes: determining the format of the audio frame corresponding to the decoding start frame identification; in the case where the format is a preset format, starting traversing in the preset frame sequence with the frame information corresponding to the target frame index as a start point. The target frame index is the frame index obtained by tracing the preset frame index difference forward based on the start frame index in the decoding start frame identification. Acquiring the segment data to be decoded in the audio resource associated with the corresponding audio resource identification according to the decoding start frame identification and the decoding end frame identification includes: acquiring the segment data to be decoded in the audio resource associated with the corresponding audio resource identification according to the target frame identification corresponding to the target frame index and the decoding end frame identification. For audio resources with some format, the audio frames may not be completely independent, and a certain number of audio frames (which can be called pre-frames) can be traced forward and added to the segment data to be decoded to ensure the integrity and accuracy of the decoded data. The preset frame index difference can be set according to the preset format. Exemplarily, the preset format may include the Moving Picture Experts Group Audio Layer III (MP3) format, and the corresponding preset frame index difference can be 1. It should be noted that for some special cases, for example, the decoding start frame identification is 0, which means that the first audio frame in the target audio resource needs to be decoded, in this case, the decoding start frame identification can be regarded as the target frame identification.

In some embodiments, in the case where the format is the preset format, decoding the segment data to be decoded to obtain the corresponding target decoded data includes: decoding the segment data to be decoded to obtain corresponding initial decoded data; remove redundant decoded data from the initial decoded data to obtain corresponding target decoded data. The redundant decoded data include decoded data of the audio frame corresponding to the frame index prior to the start frame index. For the preset format, the segment data to be decoded determined in the above steps contains redundant data of pre-frames. Therefore, the initial decoded data obtained by decoding also include decoded data of the pre-frames. In order to avoid the repeated use of decoded data, such as repeated playback, the decoded data of the pre-frames can be removed.

In some embodiments, after decoding the segment data to be decoded to obtain the corresponding target decoded data, the method further includes recording the decoding end frame identification and the decoding duration corresponding to the target decoded data. After setting the preset traversal termination condition mentioned above, the actual decoding duration may be different from the target decoding duration, timely recording the current decoding position and the actual decoding duration makes it easier to continue decoding on this basis in the future.

In application scenarios involving web front-end, the web front-end usually perform full decoding on audio files when processing the audio files. When the audio files are large or have a long duration (such as tens of minutes, or even more than an hour), the decoding process can easily occupy a large amount of memory and cause browser crashes, and the operation of a large amount of memory will seriously affect machine performance. At the same time, the full decoding process is time-consuming and difficult to ensure the timeliness of audio processing. The audio processing scheme in the embodiments of the present disclosure can be applied to the application scenarios of web front-end.

In some embodiments, this method can be applied to the web front-end. Before determining the decoding start frame identification and the decoding end frame identification in the preset frame sequence, the method also includes: performing frame division processing on the audio resource to obtain the frame information of the plurality of audio frames in the audio resource; storing the obtained frame information into the preset frame sequence at the web front-end. Maintaining the preset frame sequence at the web front-end, without the need to store full amount of decoded data, thereby reducing the large amount of memory consumption and improving the performance of the browser and the device. The audio resource being performed by frame division processing may include all or part of the audio resources involved in the current session.

In some embodiments, before determining the decoding start frame identification and the decoding end frame identification in the preset frame sequence, the method further includes: acquiring meta information of the audio resource, in which the meta information includes storage information of the audio resource, the storage information includes the storage location and/or the resource data of the audio resource; storing the meta information in the resource table at the web front-end, in which the resource table includes the association relationship between the audio resource identification involved in the current session and the storage information. Correspondingly, acquiring the segment data to be decoded in the audio resource associated with the corresponding audio resource identification according to the decoding start frame identification and the decoding end frame identification includes: acquiring the target storage information associated with the corresponding audio resource identification from the resource table according to the decoding start frame identification and the decoding end frame identification, and acquiring the segment data to be decoded based on the target storage information. The storage information corresponding to the audio resource can be stored in the form of the resource table at the front end, making it convenient to quickly acquire the segment data to be decoded through the resource table.

Exemplarily, the meta information may include global information of the audio resource and the storage information of the audio resource. The storage information includes the storage location of the audio resource and/or the resource data. The storage location may include a Uniform Resource Locator (URL) address or a local storage path, etc. The resource data can be understood as the complete data of the audio resource. Generally, in order to save the storage resource, the storage location and the resource data can be chosen to exist one. In addition, the meta information may also include the format of the audio resource (which may be an enumeration type), the total file size of the audio resource (the unit may be byte), the total duration of the audio resource (the unit may be second), the sampling rate of the audio resource (the unit may be hertz), the number of audio channels in the audio file, and other information (such as custom information) and so on.

In some embodiments, the method may also include: receiving a preset audio editing operation; according to the frame identification to be adjusted indicated by the preset audio editing operation, performing the corresponding editing operation on the corresponding frame information in the preset frame sequence, to achieve audio editing. The editing operation includes deleting the frame information and/or adjusting the sequence of the frame information. Audio editing of the audio frame granularity can be achieved by editing the frame information in the frame sequence without operating the original resource data, which can greatly improve audio editing efficiency and accuracy.

Exemplarily, the preset audio editing operation may include insertion, deletion, sorting, and the like. The number of the frame identification to be adjusted indicated by different preset audio editing operations may be different. When there are multiple frame identifications to be adjusted, the included audio resource identifications may be the same or different. For example, for insertion, the frame identification to be adjusted may include the frame identification of the audio frame to be inserted (which may be referred to as the first frame identification, and the number may be one or more), and may also include the frame identification of the audio frame used to represent the insertion position (which may be referred to as the second frame identification). For example, the frame information corresponding to the first frame identification is inserted after the frame information corresponding to the second frame identification. For example, for deletion, the frame identification to be adjusted may include the frame identification of the audio frame to be deleted. For example, for sorting, the frame identification to be adjusted may include multiple frame identifications of the audio frames to be sorted (which may be referred to as the third frame identification). The preset audio editing operation may also indicate a target sorting to reorder the frame information corresponding to multiple third frame identifications according to the target sorting for more accurate audio editing.

In some embodiments, the preset frame sequence also includes waveform summary information corresponding to the plurality of audio frames; the method further includes: in response to receiving a preset waveform drawing instruction, acquiring the target waveform summary information corresponding to the corresponding frame information in the preset frame sequence according to the frame identification to be drawn indicated by the preset waveform drawing instruction; and drawing the corresponding waveform graph according to the target waveform summary information. By storing the waveform summary information corresponding to the plurality of audio frames in the preset frame sequence, there is no need to decode the audio data when the waveform graph is needed to be drawn, and the waveform graph can be drawn directly according to the waveform summary information of the audio frame to be drawn, which can effectively improve the efficiency of drawing the waveform graph.

Exemplarily, the waveform summary information may include multiple amplitude values, and may also include the time interval between every two adjacent amplitude values. The multiple amplitude values may be uniformly or non-uniformly distributed in the time dimension, without any specific limitations. The preset waveform drawing instruction may be automatically generated according to the current scene or generated according to the user input operation.

In some embodiments, before acquiring the target waveform summary information corresponding to the corresponding frame information in the preset frame sequence, the method further includes: decoding the audio resource corresponding to the preset frame sequence; for the decoded frame data of each audio frame after decoding, dividing the current decoded frame data into a first preset number of sub interval data, determining the interval amplitude corresponding to a plurality of sub interval data, and determining the waveform summary information corresponding to the current audio frame according to a plurality of interval amplitudes; storing the waveform summary information corresponding to the plurality of audio frames into the preset frame sequence and establishing an association with the corresponding frame information. By dividing the decoded frame data into intervals, and determining the interval amplitude on a sub interval basis, the waveform summary information corresponding to the plurality of audio frames can be quickly and accurately obtained and stored in the preset frame sequence, which facilitates subsequent waveform drawing.

Exemplarily, when dividing the intervals, they can be divided in accordance with the equal interval mode, which means that the size of each interval can be consistent, thereby ensuring the distribution uniformity of the interval amplitudes and more accurately reflecting the change rule of the audio signal. For example, the first preset number can be determined according to the duration of the audio frame and the preset amplitude interval. For example, the preset amplitude interval can be used to represent that the amplitude is calculated every preset duration, for example, the amplitude is calculated every 20 ms, the audio frame duration is 40 ms and the first preset number can be 2, and the current decoded frame data will be divided into 2 sub interval data. When determining the interval amplitude corresponding to the sub interval data, the maximum amplitude value in the sub interval data can be determined as the interval amplitude. After obtaining all interval amplitudes corresponding to one audio frame, the interval amplitudes can be summarized in accordance with the order of the corresponding sub interval data to form the waveform summary information corresponding to the audio frame, which can be stored in the position of the frame information corresponding to the audio frame, or be added into the frame information, thereby establishing an association with the corresponding frame information.

Exemplarily, when decoding the audio resource corresponding to the preset frame sequence, a target duration (which can be the target decoding duration mentioned above) can be set, and the audio resource can be decoded in batches based on the target duration, that is, the waveform summary information of the audio frames within the current batch is determined in batches. After a single decoding is completed and the waveform summary information is determined, the decoded data can be deleted to reduce the occupation of the storage resource.

In some embodiments, the method further includes: dividing the preset frame sequence into a second preset number of sub-sequences; for each sub-sequence, partially decoding the current sub-sequence and determining the amplitude of the sub-sequence corresponding to the current sub-sequence according to the decoded result; and drawing a waveform sketch according to the amplitude of the sub-sequence corresponding to the plurality of sub-sequence. Through partial decoding, partial amplitude information can be quickly and selectively acquired, thereby acquiring the overall change rule of the audio signal in time.

Exemplarily, when dividing the sub-sequences, they can be divided in accordance with the equal interval mode, which means that the size of each sub-sequence can be consistent, thereby ensuring the uniformity of the amplitude distribution of the sub-sequences and more accurately reflecting the overall change rule of the audio signal. The second preset number can be set according to actual needs, that is, the number of amplitudes that need to be output. For example, if it is desired to output the amplitude value of the entire preset frame sequence at the preset value with equal interval, the second preset number may be equal to the preset value.

In some embodiments, performing partial decoding on the current sub-sequence, and determining the amplitude of the sub-sequence corresponding to the current sub-sequence according to the decoded result includes: dividing the current sub-sequence into a third preset number of decoding units; for each decoding unit, acquiring the data to be decoded according to the start frame index corresponding to the current decoding unit and the preset decoded frame number, after decoding the data to be decoded, determining the maximum amplitude in the obtained decoded data as the unit amplitude of the current decoding unit; and determining the maximum unit amplitude in various unit amplitudes as the sub-sequence amplitude corresponding to the current sub-sequence. When partially decoding the sub-sequences, performing further dividing and performing partial decoding within the decoding unit in units of the decoding unit makes the distribution of partially decoded data more uniform and accurately reflects the overall change rule of the audio signal.

Exemplarily, the maximum number and the minimum number of audio frames included in a single decoding unit can be preset, and the number of audio frames included in a single decoding unit can be estimated according to the total number of frames in the current sub-sequence, so that the number of audio frames is between the maximum number and the minimum number. Then, the third preset number can be determined according to the total number of frames and the number of audio frames.

In some embodiments, the target decoded data is used to be stored in a playback buffer region, and the method further includes: determining whether to determine the decoding start frame identification and the decoding end frame identification in the preset frame sequence according to the data amount of unplayed decoded data in the playback buffer region. For the audio playback scenario, for the on-demand decoding audio decoding method, setting the playback buffer region can achieve a filled playback mode, and dynamically deciding whether more audio data decoding is required according to the remaining data amount of unplayed decoded data in the buffer region ensures smooth playback.

Exemplarily, if the data amount of unplayed decoded data is less than the preset data threshold, the decoding start frame identification and the decoding end frame identification are determined in the preset frame sequence. The decoding start frame identification can be determined according to the decoding end frame identification recorded after the last decoding is completed. For example, the frame identification of the next frame information of the frame information to which the decoding end frame identification belongs in the preset frame sequence is determined as the current decoding start frame identification.

In some embodiments, the method is applied to the web front-end, and the method also includes: synchronizing the preset frame sequence corresponding to the current session with the server. The preset frame sequence can be synchronized to the server, thereby ensuring that the preset frame sequence will not be lost in situations such as webpage refresh.

Exemplarily, other relevant data of the current session such as the resource table can also be synchronized with the server. For data that needs to be synchronized with the server, the need for compression can be determined according to the data amount. Generally, when the duration of the audio resource is long or the number of audio resources is large, the data amount of the preset frame sequence may be relatively large. In this case, the preset frame sequence can be compressed and then synchronized.

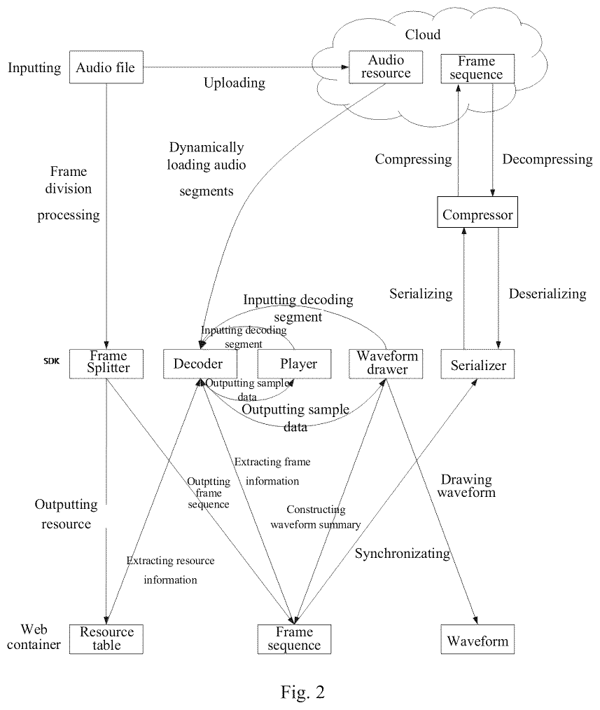

Taking the web front-end application scenario as an example to illustrate the embodiments of the present disclosure. FIG. 2 is an architectural diagram of an audio processing scheme provided by the embodiments of the present disclosure. This architecture mainly includes cloud, Software Development Kit (SDK), and Web container. The audio processing method provided by the embodiments of the present disclosure can be implemented through the SDK, which can be understood as packaged encapsulations and interface exposures of the functionality implemented by the audio processing method. The SDK may include a frame splitter, a decoder, a player, a waveform drawer, a serializer, and a compressor, etc. The frame splitter is responsible for analyzing the source file, extracting meta information and frame information; the decoder encapsulates the function of decoding audio by segments, serving for the player and the waveform drawer; the player encapsulates the ability to load, decode and play audio in time; the waveform drawer is responsible for drawing waveform and constructing waveform summaries for frames; the serializer is responsible for serializing the frame information into binary data and corresponding deserialization, which facilitates persistent storage; the compressor is responsible for compressing and decompressing the serialized data; the web container contains the data that the web front-end needs to maintain when applying the SDK, which can include the resource table, the frame sequence (i.e., the preset frame sequence), and the waveform (waveform graph).

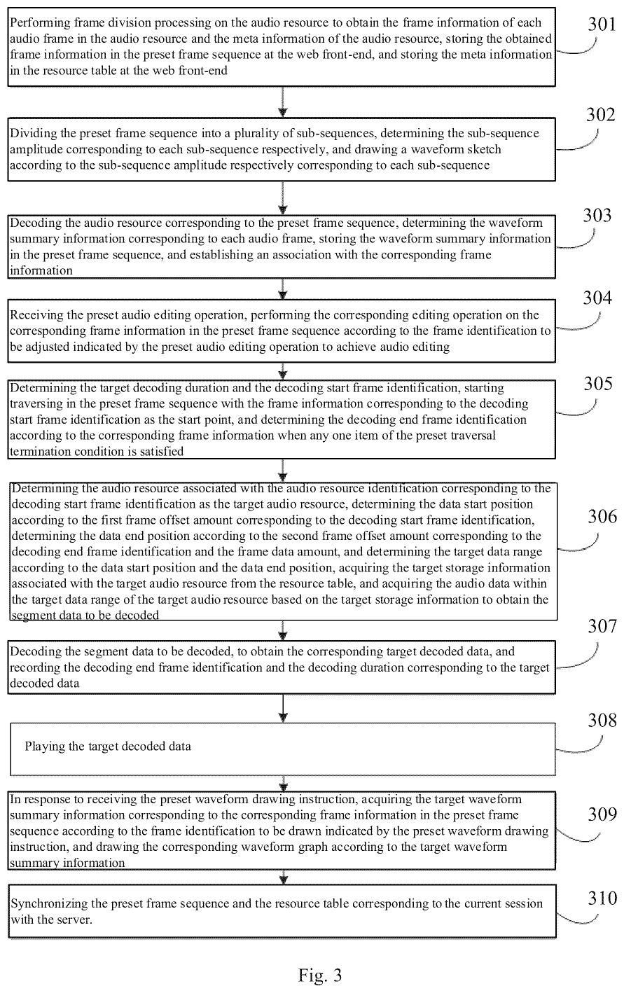

FIG. 3 is a flowchart of another audio processing method provided by the embodiments of the present disclosure. The embodiments of the present disclosure are improved based on various example schemes in the above embodiments, which can be understood in conjunction with FIG. 3.

Specifically, this method includes the following steps.

Step 301: performing frame division processing on the audio resource to obtain the frame information of a plurality of audio frames in the audio resource and the meta information of the audio resource, storing the obtained frame information in the preset frame sequence at the web front-end, and storing the meta information in the resource table at the web front-end.

Exemplarily, a frame splitter can be used to perform frame division processing on the source file corresponding to the audio resource. For audio files with different formats, the frame division processing method may be different. Before frame division processing, the format of the audio resource can be analyzed first, and then the corresponding frame division method can be matched, that is, using the frame splitter of the corresponding format to perform the frame division processing. For example, the estimated file format can be determined according to the file name suffix, and the source file can be checked to determine whether the source file is in the estimated file format (i.e., to determine whether the file name suffix matches the actual format). If the source file is in the estimated file format, the frame splitter corresponding to the estimated file format can be selected. If it is not the estimated file format, the preset file format set can be traversed to determine the format that matches the source file as the target format, and then the frame splitter corresponding to the target format can be selected. The preset file format set may include all audio file formats supported by the embodiments of the present disclosure, such as MP3, MP4, Windows Wave (WAV), and Advanced Audio Coding (AAC), which will not be specifically limited.

After the frame division processing, the obtained meta information of the audio resource may include the audio format enumeration type (type), total audio file size (size), total audio duration (duration), audio file storage address (url), complete audio file data (generally, the data do not exist at the same time as the url), audio file sampling rate (sampleRate), audio file channel count (channelCount) and so on. The frame information may include the resource ID (uri) associated with the frame, the original order (index, usually starting from 0) of the frame in all frames of the original audio file, the startposition (offset) of the frame in the original audio file, the size (size) of the frame in the original audio file, and the number of sampling points (sampleSize) stored per channel of the frame and so on. The preset frame sequence is constructed according to the above frame information. The frame identification includes uri and index. The preset frame sequence may also include waveform summary information (wave), which is subsequently constructed by the waveform drawer. When constructing the preset frame sequence, storage space for the wave can be reserved and filled after the waveform drawer obtains the waveform summary information.

Step 302: dividing the preset frame sequence into a plurality of sub-sequences, determining sub-sequence amplitudes corresponding to the plurality of sub-sequence respectively, and drawing a waveform sketch according to the sub-sequence amplitude respectively corresponding to each sub-sequence.

For example, the preset frame sequence is divided into a second preset number of sub-sequences. For each sub-sequence, the current sub-sequence is divided into a third preset number of decoding units. For each decoding unit, the data to be decoded is acquired according to the start frame identification corresponding to the current decoding unit and the preset decoded frame number. After decoding the data to be decoded, the maximum amplitude of the obtained decoded data is determined as the unit amplitude of the current decoding unit. The maximum unit amplitude of the unit amplitudes is determined as the sub-sequence amplitude corresponding to the current sub-sequence, and the waveform sketch is drawn according to the sub-sequence amplitude respectively corresponding to each sub-sequence.

Exemplarily, waveform drawing is divided into first time drawing and drawing according to the waveform summary. After frame division is completed, the two processes of first time drawing and constructing the waveform summary can be carried out in parallel. In the first time drawing, partially decoding the audio, to quickly draw a rough waveform sketch. In this step, the waveform sketch can be drawn by the waveform drawer.

For example, the preset frame sequence (frames), the resource table (resourceMap), and the number of amplitudes to be output (i.e., the second preset number, which can be recorded as ampCount) can be input into the waveform drawer. The waveform drawer outputs the amplitude values of the entire preset frame sequence at the ampCount equal division, i.e., outputs ampCount amplitude values (the range of each amplitude value can be between 0 and 1), to form the waveform sketch.

Exemplarily, the following parameters can be set: the minimum number of frames per decoding unit (such as minSegLen=6), the maximum number of frames per decoding unit (such as maxSegLen=60), and the number of frames for each decoding (i.e., the preset decoded frame number, such as decodeFrameCount=3).

For the current preset frame sequence, calculate the average number of frames in each interval avgRangeLen=frames.length/ampCount if the current preset frame sequence is divided into ampCount intervals, in which frames.length represents the number of frame information in the preset frame sequence. If avgRangeLen is less than minSegLen, it means that ampCount is too high, resulting in a large amount of data to be decoded, which approximates full decoding. Therefore, the first time drawing process can be terminated, and the waveform graph can be drawn according to the summary after the waveform summary is constructed. If avgRangeLen is not less than minSegLen, the frames can be divided into ampCount segments (sub-sequences) equal in time, and the following operations are performed for each segment.
a. Recording the start frame serial number and the end frame serial number of the current segment (i.e., the serial number of the frame information in the preset frame sequence) as begin to end.
b. Calculating the decoding unit length segLen according to the current segment length end-begin.

For example, (end-begin)/n can be calculated, rounded and adjusted to the range of minSegLen to maxSegLen, where n can be preset and the specific value is not limited, for example, n can be 10.
c. Calculating the number of decoding units segCount (the third preset number) contained in the current segment according to segLen.
d. For each decoding unit of the current segment, perform the following operations.

Recording the start frame bit of the current decoding unit as beginIndex (equivalent to the decoding start frame identification), calling the decoder, start decoding decodeFrameCount frames of data from beginIndex, and find the maximum amplitude in the decoded result as the unit amplitude of the current decoding unit.
e. After obtaining the unit amplitude corresponding to each decoding unit in the current segment, the maximum unit amplitude is used as the segment amplitude (sub-sequence amplitude) of the current segment.

When drawing the waveform for the first time, on-demand sampling and decoding of the audio resource greatly reduces the first drawing time. The longer the audio is, the more significant the improvement effect is. It has been verified that, for 90-minute audio in MP3 format, the performance is improved by more than 10 times compared to full decoding.

Step 303: decoding the audio resource corresponding to the preset frame sequence, determining the waveform summary information corresponding to the plurality of audio frames, storing the waveform summary information in the preset frame sequence, and establishing an association with the corresponding frame information.

For example, the audio resource corresponding to the preset frame sequence is decoded. For the decoded frame data of each decoded audio frame, the current decoded frame data is divided into the first preset number of sub interval data, the interval amplitudes corresponding to the plurality of sub interval data is determined, and the waveform summary information corresponding to the current audio frame is determined according to a plurality of interval amplitudes. The waveform summary information corresponding to the plurality of audio frame is stored in the preset frame sequence and an association with the corresponding frame information is established.

Exemplarily, in the process of constructing the waveform summary, the preset frame sequence (frames) and the resource table (resourceMap) can be input into the waveform drawer. The waveform drawer outputs the wave attribute of each audio frame, which is the waveform summary information, the format can be Uin8Array, and each amplitude can be a value between 0 and 255. The following parameters can be set: preset amplitude interval (msPerAmp) and target duration (decodeTime, i.e., the duration of each decoding).

For example, the decoder is called to perform full decoding with decodeTime as the single decoding target duration. During each decoding process, the frame range beginIndex (equivalent to the decoding start frame identification) to endIndex (equivalent to the decoding end frame identification) for this decoding and the decoded data Data are recorded, each frame contained is traversed, and the following operations are performed for each frame.
a. Calculating the range of the corresponding data in Data according to the start and end times of the frame: frameBeginSampleIndex to frameEndSampleIndex, and cutting the data out of the Data, in which the data is denoted as frameData (decoded frame data);
b. Calculating the number, Count (the first preset number), of amplitude values that need to be generated for this frame according to the frame duration and msPerAmp parameter, that is, the frame duration/msPerAmp.
c. Dividing the frameData equally into Count intervals (sub interval data), and for each interval, finding the maximum amplitude value as the amplitude of that interval (interval amplitude), finally, obtaining a Uint8Array containing Count amplitude values, which is denoted as waveform summary information, and adding the waveform summary information as a wave attribute to the frame information in the preset frame sequence.

By creating the waveform summary at once and saving it in the preset frame sequence, subsequent waveform drawing does not require decoding operations, resulting in very high performance.

Step 304: receiving the preset audio editing operation, performing the corresponding editing operation on the corresponding frame information in the preset frame sequence according to the frame identification to be adjusted indicated by the preset audio editing operation to achieve audio editing.

Exemplarily, when constructing the preset frame sequence for the first time, the frame information can be arranged in accordance with the order of the original audio frames in the audio resource. During use, there may be various editing requirements, for example, some audio frames in audio 1 are desired to be inserted between two audio frames in audio 2, in this case, the embodiments of the present disclosure do not require any operations on the decoded data, by operating the preset frame sequence to adjust the order of the frame information, editing can be quickly completed.

Step 305: determining the target decoding duration and the decoding start frame identification, starting traversing in the preset frame sequence with the frame information corresponding to the decoding start frame identification as the start point, and determining the decoding end frame identification according to the corresponding frame information when any one item of the preset traversal termination condition is satisfied.

The preset traversal termination condition includes the items: the cumulative duration of the audio frames corresponding to the traversed frame information reaches the target decoding duration, the audio resource identification in the current frame information is inconsistent with the audio resource identification in the previous frame information, the frame index in the current frame information is not continuous with the frame index in the previous frame information, and the frame index in the current frame information is the last one in the audio resource to which it belongs.

Exemplarily, after editing on the basis of the initial preset frame sequence, there may be a situation where the frame information of audio frames of other audio resources is inserted between the frame information of two audio frames of the same audio resource. In this case, in order to ensure that the data to be decoded involved in decoding come from the same audio resource and are continuous in the audio resource, the above preset traversal termination condition is set to dynamically determine the decoding end frame identification.

For example, whether to determine the target decoding duration and the decoding start frame identification can be determined according to the data amount of unplayed decoded data in the playback buffer region. When a webpage is first opened, the playback buffer region is usually empty. In this case, this step can be executed after the frame division processing is completed. In this case, the target decoding duration can be determined according to the setting of the player, and the decoding start frame identification can be the frame identification in the first frame information of the preset frame sequence. During the duration of the session, it can be determined whether this step needs to be executed according to the actual situation.

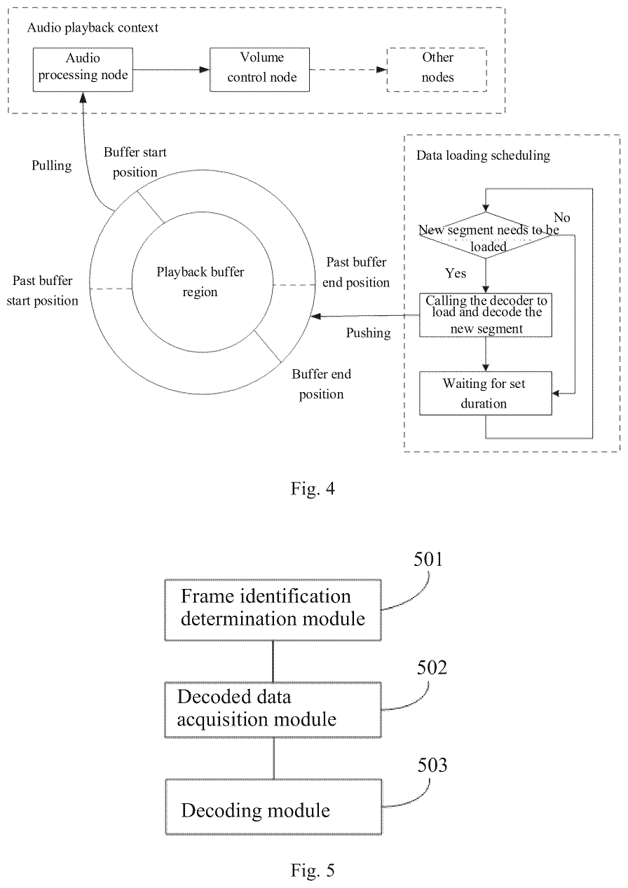

FIG. 4 is a schematic diagram of an audio playback control process provided by the embodiments of the present disclosure. As shown in FIG. 4, a ring-shaped playback buffer region can be set, and whether to decode the new segment currently can be determined through a data loading scheduling strategy. The audio playback context (AudioContext) in FIG. 4 may contain one or more audio processing nodes, such as ScriptPeocessor, which can process the audio data through a script and control the content to be played by filling the audio processing node with the decoded audio data. The volume control node (GainNode) can be used for playback control, ScriptPeocessor is connected to the node during playback, and ScriptPeocessor is disconnected with the node when paused. The playback buffer region, also known as the data buffer region, may be a ring buffer region (RingBuffer). The loaded audio data will be written to the playback buffer region, and the audio data will be read from the playback buffer region and filled into the ScriptPeocessor during playback. The data loading scheduling strategy will continuously or periodically determine whether new data needs to be loaded as the playback progress progresses. If necessary, the decoder will be called to load the new data and write the data into the playback buffer region. In the embodiments of the present disclosure, a fill type playback design can be implemented based on ScriptPeocessor to better fit the real-time loading playback scenarios, ensure smooth playback, and enhance the perception and control of the playback progress and status.

Exemplarily, the preset frame sequence, the resource table, the decoding start frame identification, the target decoding duration, and the decoding sampling rate can be input to the decoder, and the actual decoded frame identification, actual decoded segment duration, decoded sampling data, and whether the file end of the audio resource has been reached are output by the decoder.

Exemplarily, if the frame type of the audio frame corresponding to the decoding start frame identification is MP3, the previous frame index of the frame index of in the decoding start frame identification can be determined first. If the previous frame index exists, its corresponding frame identification will be used as the new decoding start frame identification, and the traversal of frame information will begin, that is, the traversal is started from the frame information of the previous frame of the start frame to be decoded in the original audio.

Step 306: determining the audio resource associated with the audio resource identification corresponding to the decoding start frame identification as the target audio resource, determining the data start position according to the first frame offset amount corresponding to the decoding start frame identification, determining the data end position according to the second frame offset amount corresponding to the decoding end frame identification and the frame data amount, and determining the target data range according to the data start position and the data end position, acquiring the target storage information associated with the target audio resource from the resource table, and acquiring the audio data within the target data range of the target audio resource based on the target storage information to obtain the segment data to be decoded.

Exemplarily, after the traversal is completed, the first frame (beginFrame) and the last frame (endFrame) that need to be decoded are obtained. As the preset traversal termination condition can ensure that these two frames and the intermediate frame belong to the same audio resource and are in continuous positions in the source file, a Hypertext Transfer Protocol (HTTP) data request can be made, with the request address being resourceMap[beginFrame.uri].url, the request data range: beginFrame.offset˜endFrame.offset+endFrame.size−1. After the data request is successful, the segment data to be decoded (AudioClipData) can be obtained.

Step 307: decoding the segment data to be decoded, to obtain the corresponding target decoded data, and recording the decoding end frame identification and the decoding duration corresponding to the target decoded data.

Exemplarily, after AudioClipData is obtained, the audio decoding interface at the web front-end (such as BaseAudioContext.decodeAudioDate) can be called for decoding to obtain the decoded audio sampling data.

For example, for the case where the above audio frame is in MP3 format, the initial decoded data obtained by calling the audio decoding interface is cropped to remove redundant decoded data and obtain the target decoded data.

Step 308: playing the target decoded data.

Exemplarily, as mentioned above, the target decoded data obtained after decoding may be first pushed to the playback buffer region, and then filled into the audio processing node for playback when needed.

Step 309: in response to receiving the preset waveform drawing instruction, acquiring the target waveform summary information corresponding to the corresponding frame information in the preset frame sequence according to the frame identification to be drawn indicated by the preset waveform drawing instruction, and drawing the corresponding waveform graph according to the target waveform summary information.

Exemplarily, the waveform drawer can also be responsible for drawing the waveform graph according to the waveform summary information. When the waveform graph is drawn according to the waveform summary information, the waveform graph corresponding to the entire preset frame sequence can be drawn, in this case, the frame identification to be drawn may be all, or the waveform graph corresponding to a part of the frame information in the preset frame sequence can be drawn, in this case, the frame identification to be drawn may include a start frame identification to be drawn and an end frame identification to be drawn.

Exemplarily, taking the waveform graph corresponding to the entire preset frame sequence as an example, a frame sequence, a resource table, and the number of output amplitudes (which can be recorded as the preset amplitude number) can be input to the waveform drawer. The preset frame sequence is divided equally in time into a preset amplitude number of sub-sequences. For each sub-sequence, determining the start frame identification and the end frame identification corresponding to the current sub-sequence, traversing the waveform summary information corresponding to all frame information from the frame information to which the start frame identification belongs to the frame information to which the end frame identification belongs, determine the maximum amplitude value as the amplitude value corresponding to the current sub-sequence, and obtain a preset amplitude number of amplitude values, so as to quickly obtain the waveform graph.

Step 310: synchronizing the preset frame sequence and the resource table corresponding to the current session with the server.

Exemplarily, after the preset frame sequence and the resource table are obtained for the first time, they can be synchronized to the cloud, and can also be synchronized continuously during the session duration. It should be noted that the synchronization process may be real-time, or may be triggered every preset time interval, or may be triggered when the resource table or the preset frame sequence changes, which will not be limited specifically.

Exemplarily, the resource table generally has a small amount of data, which can be stored in JSON format without serialization and compression processing. The preset frame sequence generally has a large amount of data. The preset frame sequence can be serialized into binary format and then compressed, such as gzip compression, to meet the requirements of network transmission. Generally, it can achieve the effect that frame information only accounts for about 1.2M data per hour.

Exemplarily, the frame field enumeration (FrameField) and the value type of each field (FrameType) can be defined, so that each field name of the frame can be stored by a unit8, and the field values are read and written in a specific format. The waveform summary information can adopt a custom data format, with a structure where the first byte stores the number of amplitudes, and each subsequent byte stores the amplitude value of each amplitude. Traversing each field in the frame, writing the field id in unit8 format, then writing the specific value according to the field value type, and then processing the next field in the same way. After all fields are serialized, writing the total length in the unit8 format at the beginning of the serialization result. The serialization of multiple frames can concatenate the serialization result of each frame to obtain the serialization result of the preset frame sequence.

The audio processing method provided by the embodiments of the present disclosure performs frame division processing on the audio resource and outputs a frame sequence and a resource table, which can realize on-demand decoding when decoding audio is required, and can support the mixed storage of different audio resources and frames of different formats in the preset frame sequence, automatically calculate and load required audio segments based on the inputs and the characteristics of frames, which makes decoding more flexible and improves audio processing efficiency. By adopting a parallel first time drawing waveform process and a waveform summary construction process, the first drawing time can be greatly reduced through partial decoding way for the first drawing. After the waveform summary information is constructed at once, the performance of subsequent waveform drawing can be greatly improved. Moreover, the resource table and frame sequence are synchronized to the cloud timely, and the data transmission amount is reduced through serialization and compression processing, which ensures that the session information is not lost.

FIG. 5 is a structural diagram of an audio processing device provided by the embodiments of the present disclosure, which can be implemented by software and/or hardware and can generally be integrated into an electronic apparatus. Audio processing can be performed by executing the audio processing method. As shown in FIG. 5, the device includes:
a frame identification determination module 501, configured to determine a decoding start frame identification and a decoding end frame identification in a preset frame sequence, in which the preset frame sequence includes frame information of a plurality of audio frames in at least one audio resource, the frame information includes a frame identification, the frame identification includes an audio resource identification and a frame index, the audio resource identification is used to represent an identity of an audio resource to which a corresponding audio frame belongs, the frame index is used to represent an order of a corresponding audio frame in all audio frames of an audio resource to which the corresponding audio frame belongs;
a decoded data acquisition module 502, configured to acquire segment data to be decoded in an audio resource associated with a corresponding audio resource identification according to the decoding start frame identification and the decoding end frame identification; and
a decoding module 503, configured to decode the segment data to be decoded to obtain corresponding target decoded data.

The audio processing device provided by the embodiments of the present disclosure stores the frame information of the plurality of audio frames in the audio resource in sequence form in advance. When decoding is required, the range of data to be decoded is accurately located according to the decoding start frame identification and the decoding end frame identification. The segment data is acquired from the corresponding audio resource and decoded without the need for full decoding of audio files, thereby achieving on-demand decoding, making decoding more flexible and improving audio processing efficiency.

For example, the frame identification determination module includes: a first determination unit, configured to determine a target decoding duration and the decoding start frame identification; and a second determination unit, configured to start traversing in the preset frame sequence with frame information corresponding to the decoding start frame identification as a start point, and determine the decoding end frame identification according to corresponding frame information when a preset traversal termination condition is satisfied; in which the preset traversal termination condition includes: a cumulative duration of audio frames corresponding to traversed frame information reaching the target decoding duration.

For example, the preset traversal termination condition further includes at least one of following items: the audio resource identification in current frame information is inconsistent with the audio resource identification in previous frame information; the frame index in current frame information is not continuous with the frame index in previous frame information; the frame index in current frame information is last one in the audio resource to which the frame index belongs. The second determination unit is configured to determine the decoding end frame identification according to the corresponding frame information when any one of the items in the preset traversal termination condition is satisfied.

For example, the frame information further includes a frame offset amount and a frame data amount; the decoded data acquisition module specifically includes a target audio resource determination unit, configured to determine the audio resource associated with the audio resource identification corresponding to the decoding start frame identification as a target audio resource; a target data range determination unit, configured to determine a data start position according to a first frame offset amount corresponding to the decoding start frame identification, determine a data end position according to a second frame offset amount corresponding to the decoding end frame identification and the frame data amount, and determine a target data range according to the data start position and the data end position, and a data acquisition unit, configured to acquire audio data within the target data range from the target audio resource, to obtain the segment data to be decoded.

For example, when the second determination unit starts traversing in the preset frame sequence with the frame information corresponding to the decoding start frame identification as the start point, the second determination unit is specifically configured to determine a format of the audio frame corresponding to the decoding start frame identification; in the case where the format is a preset format, start traversing in the preset frame sequence with frame information corresponding to a target frame index as the start point, in which the target frame index is a frame index obtained by tracing a preset frame index difference forward based on a start frame index in the decoding start frame identification; the decoded data acquisition module specifically configured to acquire the segment data to be decoded in the audio resource associated with the corresponding audio resource identification according to the target frame identification corresponding to the target frame index and the decoding end frame identification.

For example, the decoding module is specifically configured to, in the case where the format is a preset format, decode the segment data to be decoded to obtain corresponding initial decoded data; and remove redundant decoded data from the initial decoded data to obtain corresponding target decoded data, in which the redundant decoded data include decoded data of the audio frame corresponding to a frame index prior to the start frame index.

For example, the device further includes: a recording module, configured to record the decoding end frame identification and a decoding duration corresponding to the target decoded data after decoding the segment data to be decoded to obtain the corresponding target decoded data.

For example, the device is applied to a web front-end, and further includes: a frame information acquisition module, configured to perform frame division processing on the audio resource to obtain frame information of the plurality of audio frame in the audio resource before determining the decoding start frame identification and the decoding end frame identification in the preset frame sequence, and a frame information storage module, configured to store the obtained frame information into the preset frame sequence at the web front-end.

For example, the device is applied to a web front-end, and further includes: a meta information acquisition module, configured to acquire meta information of the audio resource before determining the decoding start frame identification and the decoding end frame identification in the preset frame sequence, in which the meta information includes storage information of the audio resource, the storage information includes a storage location and/or resource data of the audio resource; a meta information storage module, configured to store the meta information in a resource table at the web front-end, in which the resource table includes an association relationship between an audio resource identification involved in a current session and the storage information; correspondingly, the decoded data acquisition module is specifically configured to acquire target storage information associated with the corresponding audio resource identification from the resource table according to the decoding start frame identification and the decoding end frame identification, and acquire the segment data to be decoded based on the target storage information.

For example, the device further includes: an editing operation acquisition module, configured to receive a preset audio editing operation; an audio editing module, configured to perform a corresponding editing operation on the corresponding frame information in the preset frame sequence according to a frame identification to be adjusted indicated by the preset audio editing operation, to achieve audio editing, in which the editing operation includes deleting frame information and/or adjusting a sequence of frame information.

For example, the preset frame sequence further includes waveform summary information corresponding to the plurality of audio frames; the device further includes: a waveform summary acquisition module, configured to, in response to receiving a preset waveform drawing instruction, acquire target waveform summary information corresponding to corresponding frame information in the preset frame sequence according to a frame identification to be drawn indicated by the preset waveform drawing instruction; and waveform graph drawing module, configured to draw a corresponding waveform graph according to the target waveform summary information.

For example, the device further includes: an audio resource decoding module, configured to decode an audio resource corresponding to the preset frame sequence before acquiring the target waveform summary information corresponding to the corresponding frame information in the preset frame sequence; a waveform summary determination module, configured to, for decoded frame data of each decoded audio frame, divide current decoded frame data into a first preset number of sub interval data, determine interval amplitudes respectively corresponding to a plurality of sub interval data, and determine the waveform summary information corresponding to a current audio frame according to each interval amplitude; and a waveform summary storage module, configured to store the waveform summary information corresponding to the plurality of audio frame into the preset frame sequence and establish an association with corresponding frame information.

For example, the device further includes: a first dividing module, configured to divide the preset frame sequence into a second preset number of sub-sequences; a sub-sequence amplitude determination module, configured to, for each sub-sequence, partially decode a current sub-sequence and determine a sub-sequence amplitude corresponding to the current sub-sequence according to a decoded result; and a waveform sketch drawing module, configured to draw a waveform sketch according to the sub-sequence amplitude respectively corresponding to each sub-sequence.

For example, the sub-sequence amplitude determination module includes: a first dividing unit, configured to divide the current sub-sequence into a third preset number of decoding units; a unit amplitude determination unit, configured to, for each decoding unit, acquire data to be decoded according to a start frame identification corresponding to a current decoding unit and a preset decoded frame number, after decoding the data to be decoded, determine a maximum amplitude in obtained decoded data as a unit amplitude of the current decoding unit; and sub-sequence amplitude determination unit, configured to determine a maximum unit amplitude in various unit amplitudes as a sub-sequence amplitude corresponding to the current sub-sequence.

For example, the target decoded data is used to be stored in a playback buffer region, and the device further includes: a data amount judging module, configured to determine whether to determine the decoding start frame identification and the decoding end frame identification in the preset frame sequence according to a data amount of unplayed decoded data in the playback buffer region.

For example, the device is applied to a web front-end and further includes: a synchronizing module, configured to synchronize the preset frame sequence corresponding to a current session with a server.

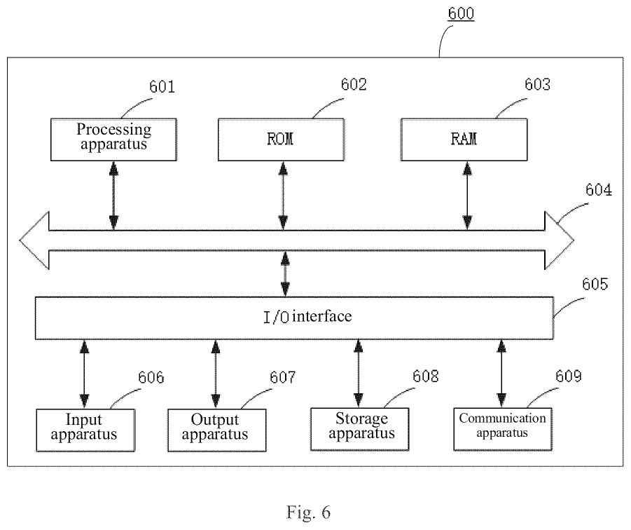

Referring to FIG. 6, FIG. 6 illustrates a schematic structural diagram of an electronic apparatus 600 suitable for implementing the embodiments of the present disclosure. The electronic apparatus in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and a fixed terminal such as a digital TV, a desktop computer, or the like. The electronic apparatus illustrated in FIG. 6 is merely an example, and should not pose any limitation to the functions and the range of use of the embodiments of the present disclosure.

As shown in FIG. 6, the electronic apparatus 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic apparatus 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic apparatus 600 to be in wireless or wired communication with other devices to exchange data. While FIG. 6 illustrates the electronic apparatus 600 having various apparatuses, it should be understood that not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus, or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic apparatus, or may also exist alone without being assembled into the electronic apparatus.

The above-mentioned computer-readable medium carries one or more programs, and when the one or more programs are executed by the electronic apparatus, the electronic apparatus is caused to: determine a decoding start frame identification and a decoding end frame identification in a preset frame sequence, in which the preset frame sequence includes frame information of a plurality of audio frames in at least one audio resource, the frame information includes a frame identification, the frame identification includes an audio resource identification and a frame index, the audio resource identification is used to represent an identity of an audio resource to which a corresponding audio frame belongs, the frame index is used to represent an order of a corresponding audio frame in all audio frames of the audio resource to which the corresponding audio frame belongs; acquire segment data to be decoded in an audio resource associated with a corresponding audio resource identification according to the decoding start frame identification and the decoding end frame identification; and decode the segment data to be decoded to obtain corresponding target decoded data.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules described in the embodiments of the present disclosure can be implemented through software or hardware. In some cases, the name of the module does not constitute a limitation on the module itself. For example, the decoding module can also be described as “a module that decodes the segment data to be decoded to obtain the corresponding target decoded data”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, an audio processing method is provided, the method includes:
determining a decoding start frame identification and a decoding end frame identification in a preset frame sequence, in which the preset frame sequence comprises frame information of a plurality of audio frames in at least one audio resource, the frame information comprises a frame identification, the frame identification comprises an audio resource identification and a frame index, the audio resource identification is used to represent an identity of an audio resource to which a corresponding audio frame belongs, the frame index is used to represent an order of a corresponding audio frame in all audio frames of the audio resource to which the corresponding audio frame belongs;
acquiring segment data to be decoded in an audio resource associated with a corresponding audio resource identification according to the decoding start frame identification and the decoding end frame identification; and
decoding the segment data to be decoded to obtain corresponding target decoded data.

For example, determining the decoding start frame identification and the decoding end frame identification in the preset frame sequence comprises:
determining a target decoding duration and the decoding start frame identification;
starting traversing in the preset frame sequence with frame information corresponding to the decoding start frame identification as a start point, and determining the decoding end frame identification according to corresponding frame information when a preset traversal termination condition is satisfied;
the preset traversal termination condition comprises:
a cumulative duration of audio frames corresponding to traversed frame information reaching the target decoding duration.

For example, the preset traversal termination condition further comprises at least one of following items:
the audio resource identification in current frame information is inconsistent with the audio resource identification in previous frame information;
the frame index in current frame information is not continuous with the frame index in previous frame information;
the frame index in current frame information is last one in the audio resource to which the frame index belongs;
determining the decoding end frame identification according to the corresponding frame information when the preset traversal termination condition is satisfied comprises:
determining the decoding end frame identification according to the corresponding frame information when any one of the items in the preset traversal termination condition is satisfied.

For example, the frame information further comprises a frame offset amount and a frame data amount; acquiring the segment data to be decoded in the audio resource associated with the corresponding audio resource identification according to the decoding start frame identification and the decoding end frame identification comprises:
determining the audio resource associated with the audio resource identification corresponding to the decoding start frame identification as a target audio resource;
determining a data start position according to a first frame offset amount corresponding to the decoding start frame identification, determining a data end position according to a second frame offset amount corresponding to the decoding end frame identification and the frame data amount, and determining a target data range according to the data start position and the data end position; and
acquiring audio data within the target data range from the target audio resource to obtain the segment data to be decoded.

For example, starting traversing in the preset frame sequence with the frame information corresponding to the decoding start frame identification as the start point comprises:
determining a format of the audio frame corresponding to the decoding start frame identification;
in a case where the format is a preset format, starting traversing in the preset frame sequence with frame information corresponding to a target frame index as the start point, in which the target frame index is a frame index obtained by tracing a preset frame index difference forward based on a start frame index in the decoding start frame identification;
acquiring the segment data to be decoded in the audio resource associated with the corresponding audio resource identification according to the decoding start frame identification and the decoding end frame identification comprises:
acquiring the segment data to be decoded in the audio resource associated with the corresponding audio resource identification according to the target frame identification corresponding to the target frame index and the decoding end frame identification.

For example, in the case where the format is a preset format, decoding the segment data to be decoded to obtain the corresponding target decoded data comprises:
decoding the segment data to be decoded to obtain corresponding initial decoded data; and
removing redundant decoded data from the initial decoded data to obtain corresponding target decoded data, wherein the redundant decoded data comprise decoded data of the audio frame corresponding to a frame index prior to the start frame index.

For example, after decoding the segment data to be decoded to obtain the corresponding target decoded data, the method further comprises:
recording the decoding end frame identification and a decoding duration corresponding to the target decoded data.

For example, the method is applied to a web front-end, before determining the decoding start frame identification and the decoding end frame identification in the preset frame sequence, the method further comprises:
performing frame division processing on the audio resource to obtain frame information of the plurality of audio frames in the audio resource; and
storing the obtained frame information into the preset frame sequence at the web front-end.

For example, before determining the decoding start frame identification and the decoding end frame identification in the preset frame sequence, the method further comprises:
acquiring meta information of the audio resource, wherein the meta information comprises storage information of the audio resource, the storage information comprises a storage location and/or resource data of the audio resource;
storing the meta information in a resource table at the web front-end, wherein the resource table comprises an association relationship between an audio resource identification involved in a current session and the storage information;
correspondingly, acquiring the segment data to be decoded in the audio resource associated with the corresponding audio resource identification according to the decoding start frame identification and the decoding end frame identification comprises:
acquiring target storage information associated with the corresponding audio resource identification from the resource table according to the decoding start frame identification and the decoding end frame identification, and acquiring the segment data to be decoded based on the target storage information.

For example, the method further comprises:
receiving a preset audio editing operation; and
performing a corresponding editing operation on the corresponding frame information in the preset frame sequence according to a frame identification to be adjusted indicated by the preset audio editing operation, to achieve audio editing, in which the editing operation comprises deleting frame information and/or adjusting a sequence of frame information.

For example, the preset frame sequence further comprises waveform summary information corresponding to the plurality of audio frames; the method further comprises:
in response to receiving a preset waveform drawing instruction, acquiring target waveform summary information corresponding to corresponding frame information in the preset frame sequence according to a frame identification to be drawn indicated by the preset waveform drawing instruction; and
drawing a corresponding waveform graph according to the target waveform summary information.

For example, before acquiring the target waveform summary information corresponding to the corresponding frame information in the preset frame sequence, the method further comprises:
decoding an audio resource corresponding to the preset frame sequence;
for decoded frame data of each decoded audio frame, dividing current decoded frame data into a first preset number of sub interval data, determining interval amplitudes respectively corresponding to a plurality of sub interval data, and determining the waveform summary information corresponding to a current audio frame according to the interval amplitudes, and
storing the waveform summary information corresponding to the plurality of audio frames into the preset frame sequence and establishing an association with corresponding frame information.

For example, the method further comprises:
dividing the preset frame sequence into a second preset number of sub-sequences;
for each sub-sequence, partially decoding a current sub-sequence and determining a sub-sequence amplitude corresponding to the current sub-sequence according to a decoded result; and
drawing a waveform sketch according to the sub-sequence amplitude respectively corresponding to each sub-sequence.

For example, partially decoding the current sub-sequence, and determining the sub-sequence amplitude respectively corresponding to the current sub-sequence according to the decoded results comprises:
dividing the current sub-sequence into a third preset number of decoding units;
for each decoding unit, acquiring data to be decoded according to a start frame identification corresponding to a current decoding unit and a preset decoded frame number, after decoding the data to be decoded, determining a maximum amplitude in obtained decoded data as a unit amplitude of the current decoding unit; and
determining a maximum unit amplitude in various unit amplitudes as a sub-sequence amplitude corresponding to the current sub-sequence.

For example, the target decoded data is used to be stored in a playback buffer region, and the method further comprises:
determining whether to determine the decoding start frame identification and the decoding end frame identification in the preset frame sequence according to a data amount of unplayed decoded data in the playback buffer region.

For example, the method is applied to a web front-end and further comprises: synchronizing the preset frame sequence corresponding to a current session with a server.

According to one or more embodiments of the present disclosure, an audio processing device is provided, the device includes:
a frame identification determination module, configured to determine a decoding start frame identification and a decoding end frame identification in a preset frame sequence, in which the preset frame sequence includes frame information of a plurality of audio frames in at least one audio resource, the frame information includes a frame identification, the frame identification includes an audio resource identification and a frame index, the audio resource identification is used to represent an identity of an audio resource to which a corresponding audio frame belongs, the frame index is used to represent an order of a corresponding audio frame in all audio frames of an audio resource to which the corresponding audio frame belongs;
a decoded data acquisition module, configured to acquire segment data to be decoded in an audio resource associated with a corresponding audio resource identification according to the decoding start frame identification and the decoding end frame identification; and
a decoding module, configured to decode the segment data to be decoded to obtain corresponding target decoded data.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

1. An audio processing method, comprising:
determining a decoding start frame identification and a decoding end frame identification in a preset frame sequence, wherein the preset frame sequence comprises frame information of a plurality of audio frames in at least one audio resource, the frame information comprises a frame identification, the frame identification comprises an audio resource identification and a frame index, the audio resource identification is used to represent an identity of an audio resource to which a corresponding audio frame belongs, the frame index is used to represent an order of a corresponding audio frame in all audio frames of the audio resource to which the corresponding audio frame belongs;
acquiring segment data to be decoded in an audio resource associated with a corresponding audio resource identification according to the decoding start frame identification and the decoding end frame identification; and
decoding the segment data to be decoded to obtain corresponding target decoded data.

2. The method according to claim 1, wherein determining the decoding start frame identification and the decoding end frame identification in the preset frame sequence comprises:
determining a target decoding duration and the decoding start frame identification;
starting traversing in the preset frame sequence with frame information corresponding to the decoding start frame identification as a start point, and determining the decoding end frame identification according to corresponding frame information in response to a preset traversal termination condition being satisfied;
wherein the preset traversal termination condition comprises:
a cumulative duration of audio frames corresponding to traversed frame information reaching the target decoding duration.

3. The method according to claim 2, wherein the preset traversal termination condition further comprises at least one of following items:
the audio resource identification in current frame information is inconsistent with the audio resource identification in previous frame information;
the frame index in current frame information is not continuous with the frame index in previous frame information;
the frame index in current frame information is last one in the audio resource to which the frame index belongs;
wherein determining the decoding end frame identification according to the corresponding frame information in response to the preset traversal termination condition being satisfied comprises: determining the decoding end frame identification according to the corresponding frame information when any one of the items in the preset traversal termination condition is satisfied.

4. The method according to claim 3, wherein the frame information further comprises a frame offset amount and a frame data amount; acquiring the segment data to be decoded in the audio resource associated with the corresponding audio resource identification according to the decoding start frame identification and the decoding end frame identification comprises:
determining the audio resource associated with the audio resource identification corresponding to the decoding start frame identification as a target audio resource;
determining a data start position according to a first frame offset amount corresponding to the decoding start frame identification, determining a data end position according to a second frame offset amount corresponding to the decoding end frame identification and the frame data amount, and determining a target data range according to the data start position and the data end position; and
acquiring audio data within the target data range from the target audio resource to obtain the segment data to be decoded.

5. The method according to claim 2, wherein starting traversing in the preset frame sequence with the frame information corresponding to the decoding start frame identification as the start point comprises:
determining a format of the audio frame corresponding to the decoding start frame identification;
in response to the format being a preset format, starting traversing in the preset frame sequence with frame information corresponding to a target frame index as the start point, wherein the target frame index is a frame index obtained by tracing a preset frame index difference forward based on a start frame index in the decoding start frame identification;
wherein acquiring the segment data to be decoded in the audio resource associated with the corresponding audio resource identification according to the decoding start frame identification and the decoding end frame identification comprises:
acquiring the segment data to be decoded in the audio resource associated with the corresponding audio resource identification according to the target frame identification corresponding to the target frame index and the decoding end frame identification.

6. The method according to claim 5, wherein, in response to the format being a preset format, decoding the segment data to be decoded to obtain the corresponding target decoded data comprises:
decoding the segment data to be decoded to obtain corresponding initial decoded data; and
removing redundant decoded data from the initial decoded data to obtain corresponding target decoded data, wherein the redundant decoded data comprise decoded data of the audio frame corresponding to a frame index prior to the start frame index.

7. The method according to claim 3, wherein, after decoding the segment data to be decoded to obtain the corresponding target decoded data, the method further comprises:
recording the decoding end frame identification and a decoding duration corresponding to the target decoded data.

8. The method according to claim 1, wherein the method is applied to a web front-end, before determining the decoding start frame identification and the decoding end frame identification in the preset frame sequence, the method further comprises:
performing frame division processing on the audio resource to obtain frame information of the plurality of audio frames in the audio resource; and
storing the obtained frame information into the preset frame sequence at the web front-end.

9. The method according to claim 8, wherein, before determining the decoding start frame identification and the decoding end frame identification in the preset frame sequence, the method further comprises:
acquiring meta information of the audio resource, wherein the meta information comprises storage information of the audio resource, the storage information comprises at least one of a storage location and resource data of the audio resource; and
storing the meta information in a resource table at the web front-end, wherein the resource table comprises an association relationship between an audio resource identification involved in a current session and the storage information;
acquiring the segment data to be decoded in the audio resource associated with the corresponding audio resource identification according to the decoding start frame identification and the decoding end frame identification comprises:
acquiring target storage information associated with the corresponding audio resource identification from the resource table according to the decoding start frame identification and the decoding end frame identification, and acquiring the segment data to be decoded based on the target storage information.

10. The method according to claim 1, further comprising:
receiving a preset audio editing operation;
performing a corresponding editing operation on the corresponding frame information in the preset frame sequence according to a frame identification to be adjusted indicated by the preset audio editing operation, to achieve audio editing, wherein the editing operation comprises at least one of deleting frame information and adjusting a sequence of frame information.

11. The method according to claim 1, wherein the preset frame sequence further comprises waveform summary information corresponding to the plurality of audio frame; the method further comprises:
in response to receiving a preset waveform drawing instruction, acquiring target waveform summary information corresponding to corresponding frame information in the preset frame sequence according to a frame identification to be drawn indicated by the preset waveform drawing instruction; and
drawing a corresponding waveform graph according to the target waveform summary information.

12. The method according to claim 11, wherein, before acquiring the target waveform summary information corresponding to the corresponding frame information in the preset frame sequence, the method further comprises:
decoding an audio resource corresponding to the preset frame sequence;
for decoded frame data of each decoded audio frame, dividing current decoded frame data into a first preset number of sub interval data, determining interval amplitudes respectively corresponding to the first preset number of sub interval data, and determining the waveform summary information corresponding to a current audio frame according to the first preset number of interval amplitudes; and
storing the waveform summary information corresponding to the first preset number of audio frames into the preset frame sequence and establishing an association with corresponding frame information.

13. The method according to claim 1, further comprising:
dividing the preset frame sequence into a second preset number of sub-sequences;
for each sub-sequence, partially decoding a current sub-sequence and determining a sub-sequence amplitude corresponding to the current sub-sequence according to a decoded result; and
drawing a waveform sketch according to sub-sequence amplitudes respectively corresponding to the second preset number of sub-sequences.

14. The method according to claim 13, wherein partially decoding the current sub-sequence, and determining the sub-sequence amplitude respectively corresponding to the current sub-sequence according to the decoded results comprises:
dividing the current sub-sequence into a third preset number of decoding units;
for each decoding unit, acquiring data to be decoded according to a start frame identification corresponding to a current decoding unit and a preset decoded frame number, after decoding the data to be decoded, determining a maximum amplitude in obtained decoded data as a unit amplitude of the current decoding unit; and
determining a maximum unit amplitude in the third preset number of unit amplitudes as a sub-sequence amplitude corresponding to the current sub-sequence.

15. The method according to claim 1, wherein the target decoded data is used to be stored in a playback buffer region, and the method further comprises:
determining whether to determine the decoding start frame identification and the decoding end frame identification in the preset frame sequence according to a data amount of unplayed decoded data in the playback buffer region.

16. The method according to claim 1, wherein the method is applied to a web front-end and further comprises:
synchronizing the preset frame sequence corresponding to a current session with a server.

17. (canceled)

18. An electronic apparatus, comprising a memory, a processor, and a computer program stored on the memory and capable of running on the processor, wherein the processor implements an audio processing method when executing the computer program, the method comprises:
determining a decoding start frame identification and a decoding end frame identification in a preset frame sequence, wherein the preset frame sequence comprises frame information of a plurality of audio frames in at least one audio resource, the frame information comprises a frame identification, the frame identification comprises an audio resource identification and a frame index, the audio resource identification is used to represent an identity of an audio resource to which a corresponding audio frame belongs, the frame index is used to represent an order of a corresponding audio frame in all audio frames of the audio resource to which the corresponding audio frame belongs;
acquiring segment data to be decoded in an audio resource associated with a corresponding audio resource identification according to the decoding start frame identification and the decoding end frame identification; and
decoding the segment data to be decoded to obtain corresponding target decoded data.

19. A non-transitory computer-readable storage medium, on which a computer program is stored, wherein the computer program implements an audio processing the method when executed by a processor, the method comprises:
determining a decoding start frame identification and a decoding end frame identification in a preset frame sequence, wherein the preset frame sequence comprises frame information of a plurality of audio frames in at least one audio resource, the frame information comprises a frame identification, the frame identification comprises an audio resource identification and a frame index, the audio resource identification is used to represent an identity of an audio resource to which a corresponding audio frame belongs, the frame index is used to represent an order of a corresponding audio frame in all audio frames of the audio resource to which the corresponding audio frame belongs;
acquiring segment data to be decoded in an audio resource associated with a corresponding audio resource identification according to the decoding start frame identification and the decoding end frame identification; and
decoding the segment data to be decoded to obtain corresponding target decoded data.

20. The medium according to claim 19, wherein determining the decoding start frame identification and the decoding end frame identification in the preset frame sequence comprises:
determining a target decoding duration and the decoding start frame identification;
starting traversing in the preset frame sequence with frame information corresponding to the decoding start frame identification as a start point, and determining the decoding end frame identification according to corresponding frame information in response to a preset traversal termination condition being satisfied;
wherein the preset traversal termination condition comprises:
a cumulative duration of audio frames corresponding to traversed frame information reaching the target decoding duration.
